(19) United States
(12) Patent Application Publication
(10) Pub. No.: US 2012/0227066 A1
(43) Pub. Date: Sep. 6, 2012

(54) MEDIA CONTENT INFORMATION PROVISION

(76) Inventors: Mikael Woxblom, Alvsjo (SE); Kenta Yasukawa, Nerima-ku (JP)

(21) Appl. No.: 13/508,400

(22) PCT Filed: Nov. 20, 2009
(86) PCT No.: PCT/SE09/51314

§ 371 Date: May 7, 2012

(51) Int. Cl. H04N 21/25

(52) U.S. Cl. 725/25

(57) ABSTRACT

A selective provision of content information of media content available at a content provider (30) to media rendering devices (12, 13, 14) present in a local network (2) is achieved by generating,at a content service provider (200) connected to a global network (3), content rights information defining rights to the media content for the media rendering devices (12, 13, 14). The content rights information is forwarded to a media server (100) implemented in the local network (2) to thereby control the media server (100) in the distribution of the content information to the media rendering devices (12, 13, 14) based on the content rights information. A controlled and selective provision of the content information in the local network (2) is thereby achieved.

### TECHNICAL FIELD

The present invention generally relates to media content information provision, and in particular such information provision to media rendering devices present in a local network.

### BACKGROUND

Digital Living Network Alliance (DLNA) is an international, cross-industry collaboration and standard that has been developed in order to facilitate consumer devices to communicate with each other in a local network and share media between the devices.

The DLNA compatible devices communicate with each other within the local network via Universal Plug and Play (UPnP), which is a set of protocols that allow devices to connect seamlessly and share data.

DLNA compatible devices are operable within a local network typically comprising multiple DLNA compatible devices, potentially of different types and manufactures. In the art, a division of DLNA compatible devices based primarily on their function in the media distribution and rendering within the local network has been used and involves, among others, Digital Media Server (DMS), Mobile DMS (M-DMS), Digital Media Player (DMP) and Mobile DMP (M-DMP).

DMS and M-DMS are devices that store media content and make it available to wired and/or wireless networked DMP and M-DMP devices. DMS and M-DMS include, among others, personal computers, network attached storage (NAS) devices, mobile phones and portable music players. A DMP or M-DMP is a device that finds content on a DMS or M-DMS and provides playback and rendering capabilities. TVs, stereos, home theatres, wireless monitors, game consoles, mobile phones and mobile media tables are illustrative examples of user equipment that can operate as DMP or M-DMP.

A Digital Media Controller (DMC) or Mobile DMC (M-DMC) is a device that finds content on a DMS or M-DMS and plays it on a Digital Media Renderer (DMR). DMC and M-DMC include Internet tablets, Wi-Fi® enabled digital cameras, personal digital assistants (PDA) and mobile phones, etc. Finally, a DMR is a device that plays content received from a DMC or M-DMC and includes devices, such as TVs, audio/video receivers, video displays, remote speakers.

Today, when the assets and media content available at a DMS is updated, the DMS broadcasts information to all connected DMP and M-DMP devices that new content information is available to fetch. The content information defines and lists the media contents and assets that are available through the DMS and can be played and rendered in the DMP or M-DMP. The DMP and M-DMP devices request the new information to thereby each have an identical copy of the content information relating to media content and assets accessible from the DMS. The user can then investigate this content information in order to determine which particular media content he or she would like to play.

A limitation with the prior art technique is that all DMPs and M-DMPs in the local network will get the same identical copy of the content information. However, in some situations it may desirable for a user to provide limited access to information of media content and assets to merely a limited number of the DMPs, for instance the TV of the user but not necessarily other TVs in the home. This is not possible according to the prior art.

### SUMMARY

Thus, there is no possibility in the prior art of achieving a selective announcement and updating of the content information to the DMP devices. This means that information relating to media content and assets recently accessible from the DMS must as a necessity according to the prior art be distributed to all DMP devices in the local network. Embodiments provide a solution to this problem.

It is a general objective to enable control of delivery of media content to media rendering devices present in a local network.

This and other objectives are met by embodiments as disclosed herein.

Briefly, a user can log into a content service provider using a user terminal to define access rights of media rendering devices available for the user in a local network to media content present at a content provider. A user identifier of the user is employed for generating content rights information defining rights for the media rendering devices to content information describing the media content at the content provider. The content rights information is transmitted to a media server present in the local network to enable a selective provision of the content information to the media rendering devices based on the content rights information.

Thus, the media server receives the content rights information from the content service provider and uses the information to identify which media rendering devices in the local network that should be allowed access to content information and optionally which part of the content information they may access. The content information is then selectively provided to the media rendering device by the media server according to the content rights information.

A user can thereby define for his/her media rendering devices which particular content that the media rendering devices may have access to. It is therefore possible to achieve a differentiated distribution of content information and media content to different media rendering devices present in a same local network.

An aspect defines a media server implementable in the local network and capable of communicating with media rendering devices associated with the user and present in the local network. The media server comprises a receiver configured to receive content rights information from a content service provider connected to a global network connected to the local network. The content rights information defines rights to media content available at at least one content provider for the media rendering devices. An information provider of the media server selectively provides content information of the media content to media rendering devices according to the rights defined by the content rights information.

Another aspect relates to a content service provider having a receiver configured to receive a user identifier associated with a user having access to media rendering devices in a local network. A rights information generator employs the user identifier for generating content rights information defining rights for the media rendering devices to content information of media content available at at least one content provider. A transmitter of the content service provider transmits the content rights information to the media server in the local network to enable a selective provision by the media server of the content information to the media rendering devices according to the content rights information.

### BRIEF DESCRIPTION OF THE DRAWINGS

The invention, together with further objects and advantages thereof, may best be understood by making reference to the following description taken together with the accompanying drawings, in which:

FIG. 1 is a schematic overview of a communication system to which embodiments can be applied;

FIG. 2 is a schematic overview of another communication system to which embodiments can be applied;

FIG. 3 schematically illustrates a possible organization of a content service provider in relation to content providers and network operators;

FIG. 4 is a flow diagram illustrating a content information control method according to an embodiment;

FIG. 5 is a flow diagram illustrating a method of providing media content information according to an embodiment;

FIG. 6 is a signal diagram illustrating communication between included devices in the communication system according to an embodiment;

FIG. 7 is another signal diagram illustrating communication between included devices in the communication system according to an embodiment;

FIG. 8 is yet another signal diagram illustrating communication between included devices in the communication system according to an embodiment;

FIG. 9 is a further signal diagram illustrating communication between included devices in the communication system according to an embodiment;

FIG. 10 is a schematic block diagram of a media server according to an embodiment; and

FIG. 11 is a schematic block diagram of a content service provider according to an embodiment.

### DETAILED DESCRIPTION

Throughout the drawings, the same reference numbers are used for similar or corresponding elements.

Embodiments as disclosed herein relate to distribution of media content information in a communication system and in particular to enabling selective and differentiated provision of such media content information to media rendering devices present in a local network.

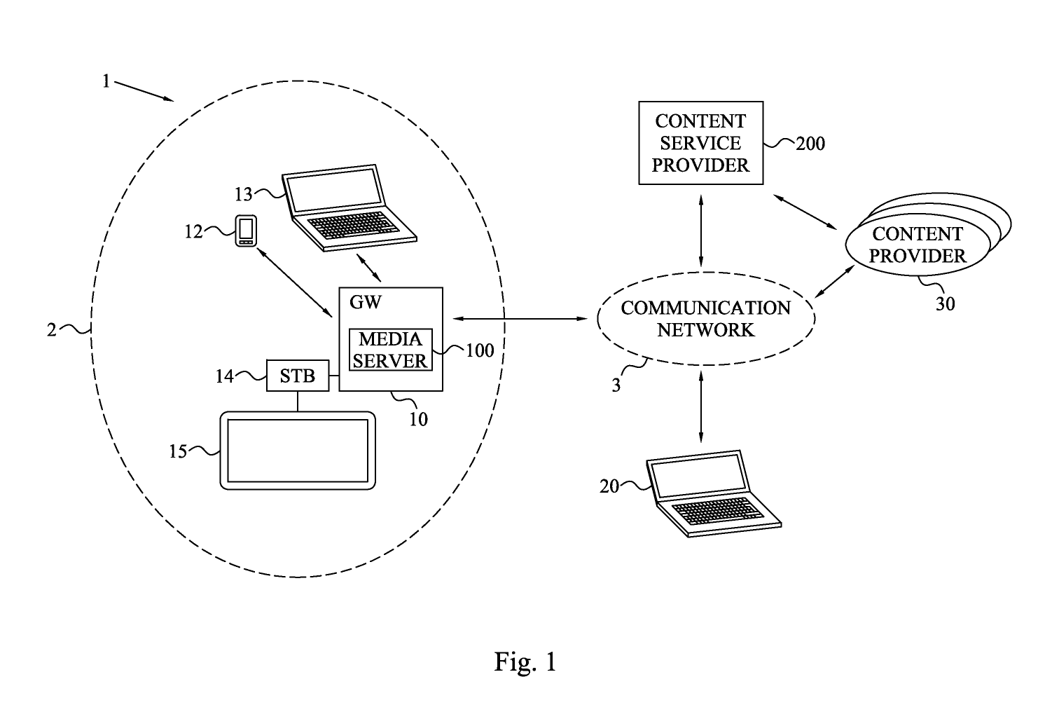

With reference to FIG. 1, the traditional approach in media content distribution in a local network 2 with DLNA compatible devices has been to arrange a DMS device storing media content and making it available to wired and/or wireless networked media rendering devices 12, 13, 14 in form of DMP and M-DMP devices. However, in such an approach the media content that is available for rendering by the media rendering devices 12, 13, 14 is limited to the actual media content that is stored locally in the DMS device.

Development has been directed towards establishing a remote DMS (rDMS) or media server 100 locally in the local network 2. The media server 100 is connected to a content service provider 200 connected to a global network 3. The content service provider 200 then has access to and can announce media content available at one more content providers 30 also connected to the global network 3. Usage of such media server 100 and remote content service provider 200, allow users to get access to vastly larger range of media content possibly from different content providers 30 as compared to only accessing locally stored media content in the DMS device.

Embodiments as disclosed herein provides a controlled and selective announcement of media content information relating to the media content that can be ordered from the content service provider 200 and delivered for rendering in any of the media rendering devices 12, 13, 14 in the local network. This control in the information announcement and the definition of content rights can be managed by a user having access to the media rendering devices 12, 13, 14. The user then has access to a user terminal 20 connected to the global network 3 and employs it for communicating with the content service provider 200 in order to define content rights information relating to the media rendering devices 12, 13, 14.

The communication system 1 illustrated in FIG. 1 comprises the global network 3 to which the user terminal 20, content service provider 200 and at least one content provider 30 are connected. The global network 3 can be a non-managed or open network, typically denoted Open Internet in the art. Alternatively, the global network 3 can be or comprise a managed or proprietary network operated by a network operator. In either case, the global network 3 comprises or is connected to one or more content providers 30 having access to media content that can be distributed to media rendering devices 12, 13, 14 present in the local network 2. These content providers 30 can be network-arranged, dedicated content providers or indeed represent consumer generated media in the form of media available from other users in their respective local networks. The advantages of the embodiments are that media content selection and distribution can be achieved from any content provider 30 connected to the global network 3. As a consequence, the user is not limited to select only among media content available locally within the local network and stored on a DMS device.

The local network 2 of the communication system 1 is sometimes denoted local area network (LAN), personal network, personal area network (PAN) but is also known in the art under other names such as home network, residential network or consumer network. In some embodiments, the local network 2 can be based on Ethernet or one of the existing wire home networking technologies, such as Home Phoneline Networking Alliance (HomePNA) or the Telecommunication Standardization Sector (ITU-T) G.hn standard, which provides a possibility of creating high-speed LAN using existing home wiring. Other examples include different LAN solutions to enable delivery of media content over IP and the customer's broadband connection, such as Asymmetric Digital Subscriber Line (ADSL), Very high-rate Digital Subscriber Line (VDSL), Public Ethernet, etc. Also wireless network solutions are possible, including combinations of wired and wireless techniques.

The media rendering devices 12, 13, 14 of the local network 2 are generally interconnected to the global network 3 through a gateway (GW) 10 providing an interface between the two networks 2, 3. This gateway 10 operates in a similar way to a router in terms of forwarding data from the local network 2, such as list requests to the global network 3 and forwarding data from the global network 3, such as content rights information, to the local network 2.

In the figure, the media server 100 has been illustrated as locally implemented in the gateway 10 providing the communication interface between the local network 2 and the global network 3.

The media rendering devices 12, 13, 14 are advantageously DLNA compatible devices. The media rendering devices 12, 13, 14, can consequently perform the roles of Digital Media Player (DMP) and Mobile DMP (M-DMP). A DMP or M-DMP is a media rendering device that finds content on the media server 100 (rDMS) and provides playback and rendering capabilities. TVs, stereos, home theatres, wireless monitors, game consoles, mobile phones and mobile media tables are illustrative examples of media rendering devices 12, 13, 14 that can operate as DMP or M-DMP. The figure illustrates an example of a local network 2, in which a mobile telephone 12, a computer 13 and a set top box (STB) 14 with connected TV-screen 15 are presented as illustrative but non-limiting example of media rendering devices.

Additionally, a Digital Media Controller (DMC) or Mobile DMC (M-DMC) and a Digital Media Renderer (DMR) operate similar to a DMP. This means that embodiments as disclosed herein can also be used in connection with a DMC as an example of a media rendering device.

In the following media content should be interpreted broadly to encompass multimedia and media data, such as video, audio, text, graphics, data delivered over IP based networks to a media rendering device 12, 13, 14 in a local network 2, where local processing, i.e. rendering and/or play back of the media content is effected.

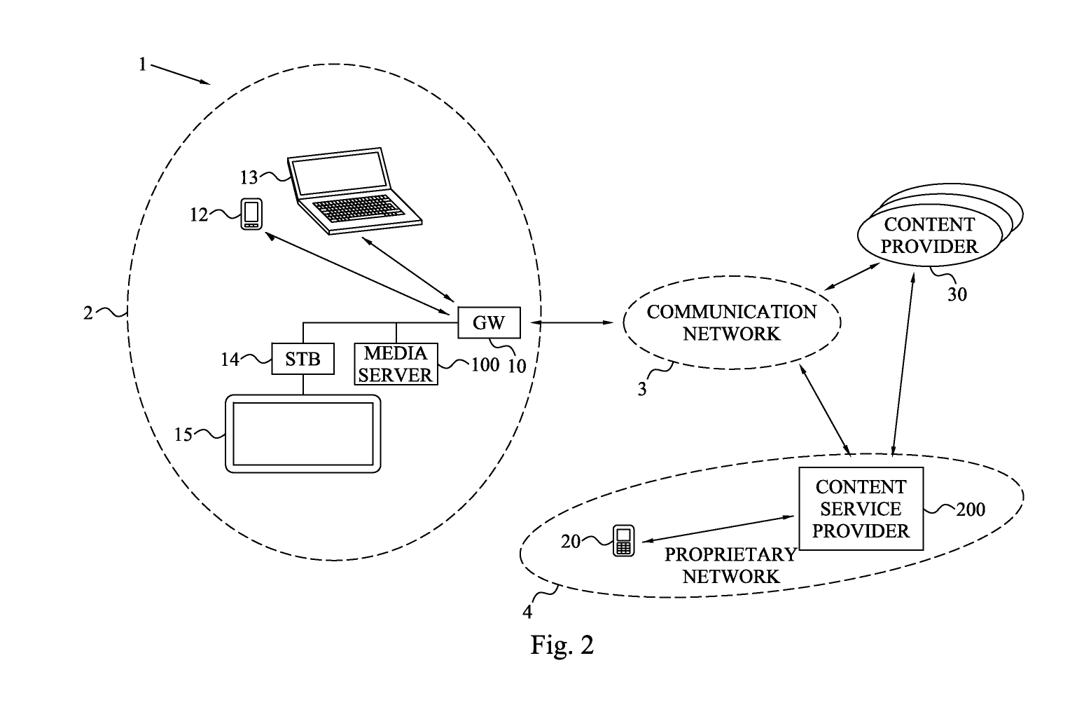

FIG. 2 illustrates an alternative layout of the communication system 1. In this case, the user terminal 20 employed for defining content rights at the content service provider 200 is represented by a mobile telephone 20 connected to a proprietary network 4 operated by a network operator. In the illustrative example, the content service provider 200 is also provided in the proprietary network 4, which in turn is connected to the global network 3, typically Internet in this example. The content providers 30 storing the actual media content that is announced through the content service provider 200 can be implemented in the proprietary network 4 or in the global network 3.

The figure also illustrates an alternative implementation of the media server 100 in the local network 2 as compared to FIG. 1. In this embodiment, the media server 100 is implemented as a stand-alone device that is connected, either by a wireless or wired connection, to the gateway 10. The media server 100 can communicate directly with the media rendering devices 12, 13, 14 or indirectly through the gateway 10.

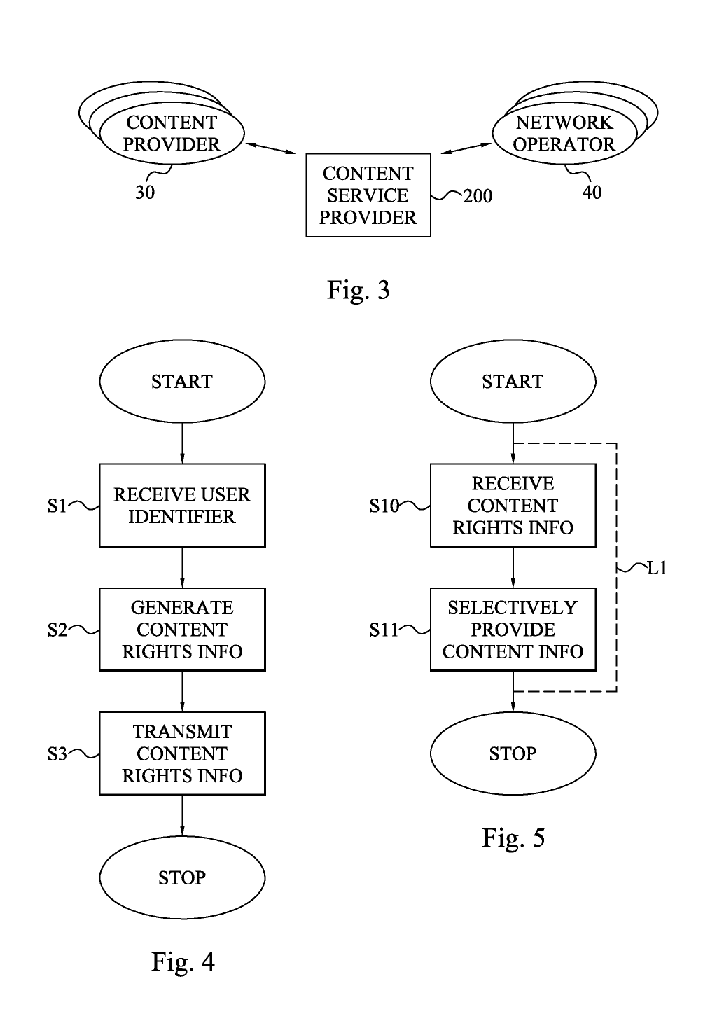

FIG. 3 is a schematic illustration showing the interrelationship of the content service provider 200, content providers 30 and network operators 40. The content service provider 200 can in an embodiment be regarded as a central server or media fabric that provides media content services to users by announcing media content assets available from the content providers 30 to the media servers present locally in the users' local networks. Thus, the content service provider 200 can receive information from various content providers 30, including network-implemented ones and optionally also user terminals and any other entity that stored media content that can be ordered and distributed to media rendering devices.

The content service provider 200 can advantageously be available for one or more network operators 40 to thereby provide the services of the content service provider 200 to the users of the networks managed by the network operators 40.

FIG. 4 is a flow diagram illustrating a content information control method according to an embodiment. The control method is preferably operable in the content service provider. In a first step S1, a user identifier associated with a user having access to media rendering devices present in a local network is received. Step S1 typically involves that the user logs in using a web browser or other user interface module implemented in his/her user terminal, such as computer (see FIG. 1) or mobile device or telephone (see FIG. 2), to a web page or site of the content service provider. The user is urged to enter a user name and a password or some other user identifier to log into his/her account at the content service provider.

The user identifier received from the user terminal in step S1 is used in step S2 to generate content rights information defining rights for the media rendering devices in the local network to content information of the media content available from one or more content providers connected to the global network. The content rights information defines, preferably for each media rendering device in the local network associated with the user, the content information that should be accessible for the media rendering device. The content rights information consequently enables a selective and controlled access to content information describing the media content that potentially is available for the media rendering devices through the media server. This means that it is possible through the content rights information to select that one or more media rendering devices should have complete access to all the content information, to select that one or more media rendering devices should merely have access to a limited part of the content information, such as from a selected subset of the content providers and/or only media content of a particular content type, such as video content. Additionally, it can be possible to define by the content rights information that one or more media rendering devices available for the user should not have any access to the content information at all. A differentiated distribution of content information is consequently achieved through the content rights information.

In the art, the DMS announces the complete content information to all the connected media rendering devices. This might not be any problem since the DMS device locally stores the media content and the user can thereby control which media content that should be entered in the media memory of the DMS device. However, with the concept of rDMS devices and allowing access to media content from multiple content providers, there is a need for a more controlled announcement and access to media content.

For instance, a user might only want some personal photographs stored in his/her user terminal, which thus also has the role of a content provider, to become displayable on his/her TV but not on any other DMP devices in the local network. A further example could be in a hotel, where a limited set of media content in terms of different free TV channels should be available to all hotel rooms, whereas other, paid TV channels should only be announced and available to those hotel rooms, where the guests have paid for the TV channels. Embodiments solve these problems through the usage of the content rights information.

The generated content rights information is transmitted in step S3 to the media server present in the local network. There the content rights information enables a selective provision of the content information by the media server to at least one of the media rendering devices in the local network. The content rights information can therefore be regarded as meta data providing instructions to the media server about how the content information listing the media content that is potentially available from the content providers should be announced to the different media rendering devices. A selective announcement of media content and thereby a selective provision of media content to the media rendering devices is achieved through the instructions defined by the content rights information.

The method then ends.

FIG. 5 is a corresponding flow diagram illustrating a method of providing media content information to media rendering devices present in a local network. FIG. 5 basically illustrates process steps operable by the media server in the local network. The method starts in step S10 where the media server receives content rights information from the content service provider. The media server uses this content rights information in step S11 for selectively providing content information to at least one of the media rendering devices present in the local network. The content rights information thereby provides instructions to the media server how content information of media content available at at least one content provider should be distributed to the media rendering devices in the local network. The method then ends.

The operation of steps S10 and S11 can be repeated one or more additional times, which is schematically illustrated by the line L1. Thus, when the media content available from the content providers is updated, for instance by adding or removing assets, new content information is generally generated by the content service provider and transmitted to the media server for announcement to the media rendering devices. In such case, updated or new content rights information is advantageously also received from the content service provider and relating to the updates of the content information. The new content rights information thereby dictates how the media server should distribute the content information updates to the media rendering devices in the local network.

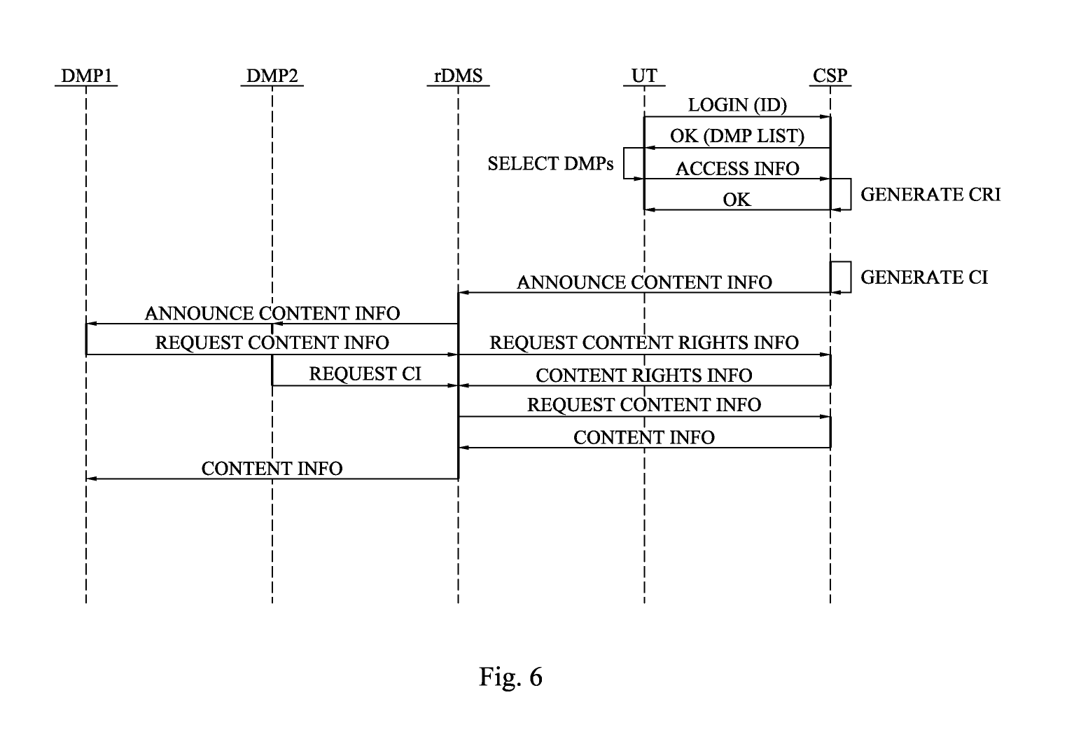

FIG. 6 is a signal diagram illustrating the signaling occurring between participating devices in connection with providing content information, including any updates, to media rendering devices according to an embodiment.

In a preferred implementation, media rendering devices, here represented by two different DMP devices, DMP1 and DMP2, first notify or announce their presence to the content service provider (CSP) using the connected gateway (not illustrated). The gateway thereby publishes the presence of the media rendering devices to the content service provider, preferably by transmitting respective IP number, device name or identifier and optionally information of device functionality to the content service provider. The content service provider typically returns with a confirmation or OK response to the gateway and preferably to the media server (rDMS) that may be implemented in or connected to the gateway. The presence publication allows the content service provider to keep and update a list of media rendering devices that are present in a local network and associated with and accessible for one or more users. Publication of the presence of media rendering devices is typically only conducted once for each media rendering device in connection with connecting it the first time to the local network. The information of the published media rendering device is preferably associated with an identifier of the user having access to the media rendering devices in the local network. The identifier can be a dedicated user identifier, an identifier of the local network or some other data allowing the content service provider to determine to which particular local network or user the media rendering devices belong.

The user preferably logs in with his/her user terminal (UT) to an account at the content service provider. This log-in procedure typically involves typing a user name and password at a web page of the content service provider accessed by a web browser implemented in the user terminal. The content service provider generates information of the media rendering devices announced to the content service provider and present in one or more local networks accessible to the user associated with the received user identifier. The information of the media rendering devices is advantageously in the form of a list with the device names of the registered media rendering devices. The information is transmitted to the user terminal and is preferably displayed for the user in the web browser. The user can thereby select and restrict access to media rendering devices of content information including updates that will be announced to the media rendering devices through the media server. Thus, the user gets the possibility of controlling how content information should be distributed among the media rendering devices and thereby also control which media content that is available for rendering at each of the media rendering devices.

There are many different embodiments in which the user can control and specify the content rights to his/her available media rendering devices present in the local network(s). For instance, the user can specify that a media rendering device should have full access to the complete DMS structure, i.e. all content information, and all assets updates relating to the DMS structure, i.e. all updates of the content information. Alternatively, the user can specify that a media rendering device should have full access to the DMS structure but only restricted access to assets updates. Thus, the media rendering device will then only receives certain of the content information updates whereas other such content information updates are not available for the media rendering device. A further alternative is that a media rendering device should have restricted access to merely a part of the DMS-structure and receive all assets updates relating to this part of the DMS-structure. The media rendering device will thereby only get access to some of the content information of the media content that is potentially available at the content providers. This alternative can be extended even further by specifying that a media rendering device should have restricted access to merely a part of the DMS-structure and additionally have restricted access to only a part of the assets updates relating to the accessible part of the DMS-structure. Further alternatives include specifying that a media rendering device should have full or limited access to the original DMS structure but not receive any content information updates or that a media rendering device should have no access to the DMS structure or any assets updates.

It is of course possible for the user to combine any of the above mentioned alternatives. Thus, one or more of the media rendering devices in the local network could be assigned by the user to have full access to the complete content information and any updates, whereas other media rendering devices should only have restricted access to the content information and/or any updates including having no access at all.

Restricting the access to content information by the user can for instance relate to the content source. Thus, the user can specify that a media rendering device should not have access to the content information relating to the media content available at a particular content provider. That media rendering device will therefore not be presented by any content information or updates relating to the media content from the content provider but could receive such content information and updates from other content providers.

Another reason for restricting access to media content could be based on media content type. The user could thereby specify that a media rendering device should only have access to media content of a particular media content type, such as audio, whereas media content of other media content types, such as video, should not be announced to the media rendering device.

Regardless of the reason for restricting access to media content, the embodiments disclosed herein enables the user to completely control the media content distribution among the media rendering devices available for him/her in the local network or the multiple, i.e. at least two, local networks that is accessible for him/her.

The user thereby selects which media rendering devices that should have access to which media content as disclosed above. Content access information defining the user-selected access to media content for a media rendering device is returned to the content service provider together with the device identifier of the media rendering device. In one embodiment, the user generates content access information for each media rendering device listed in the media rendering device information. Alternatively, the user could generate such content access information to one or a subset of the media rendering devices. In such a case, the content rights for the other media rendering devices could be according to pre-defined default rights. Such default rights preferably correspond to full access to the content information including any updates or alternatively no access to the content information or any updates.

The content service provider generates the content rights information (CRI) based on the received content access information and the associated device identifiers. The content service provider preferably also returns an acknowledgement if the access information was successfully received.

The generation of content rights information can be performed anytime by the user by simply logging in to the web site of the content service provider or by means of some web interface based log in solution. This means that the user can update or change the content access settings for the media rendering device as many times as he/she wants. The result of such an update or change will be updated content rights information that applies to the media rendering devices of the users until the next time they are changed.

The content service provider also generates content information (CI) defining the media content available from the connected content providers. The content information can be an original DMS structure which lists all the available media content. Alternatively, the content information can be updates of the DMS structure generated as media content assets have been added or removed at the content providers. In such a case, it is enough if the content information only defines these changes by instructions read by the media server and stating, for instance, add media content assets 4, 5 and 6 and remove media content assets 1 and 3. It is though possible, though less attractive from the point of view of the amount of data that needs to be sent to the media server, to include the complete new DMS structure in an update.

The content service provider announces the content information to the media server by transmitting, in this embodiment, information that new or updated content information is now available at the content service provider. This information preferably comprises address information, e.g. a link, at the content service provider from which the content information can be downloaded by the media server and presented to a media rendering device. The media server transmits an announcement of the content information excluding the address information to all media rendering devices, preferably in the form of a multicast or broadcast transmission. The media server also generates a request for content rights information that is transmitted to the content service provider. The content service provider returns the previously generated content rights information to the media server. The communication between the media server and the content service provider utilizes an identifier of the particular media server. The content service provider then stores this identifier of the media server together with the user identifier to provide a connection between user and media server and thereby local network. Alternatively, the same identifier can be used for identifying the user and the media server, e.g. in terms of an identifier of the local network

The media rendering devices respond to the announcement of the content information by returning respective requests of the content information to the media server. The media server then investigates the received content rights information in order to determine which media rendering device that should have access to the content information. In this illustrative example media rendering device DMP1 is allowed full access to the content information, whereas that user has previously defined that media rendering device DMP2 should not have access to the content information. The media server thereby, in an illustrative embodiment, uses the previously received address information to fetch the content information from the content service provider. The content information is transmitted to the media server and forwarded to the media rendering device granted access to the content information.

The media server, however, rejects the request from the media rendering device DMP2, which thereby will not get access to the content information.

In a particular embodiment, the content information is in the form of Extensible Markup Language (XML) data. Furthermore, instead of transmitting a link where the XML data can be fetched at the content service provider in the announcement, the actual XML data can be sent directly to the media server together with the announcement. In such a case, the media server can respond directly to the content information requests from the media rendering devices by, in this example, transmitting the XML data to the media rendering device DMP1 but not transmitting any XML data to the media rendering device DMP2.

In the case one of the media rendering devices should only get access to a part of the content information and at least one other media rendering device is allowed access to the complete content information or another part thereof, the content service provider preferably includes multiple addresses or links in the announcement of the content information. In such a case, one address is used by the media server for one of the media rendering devices to get the part of the content information, e.g. first XML data, whereas another address at the content service provider allows the media server to access the complete or other part of the content information, e.g. second XML data, and forward it to the at least one other media rendering device.

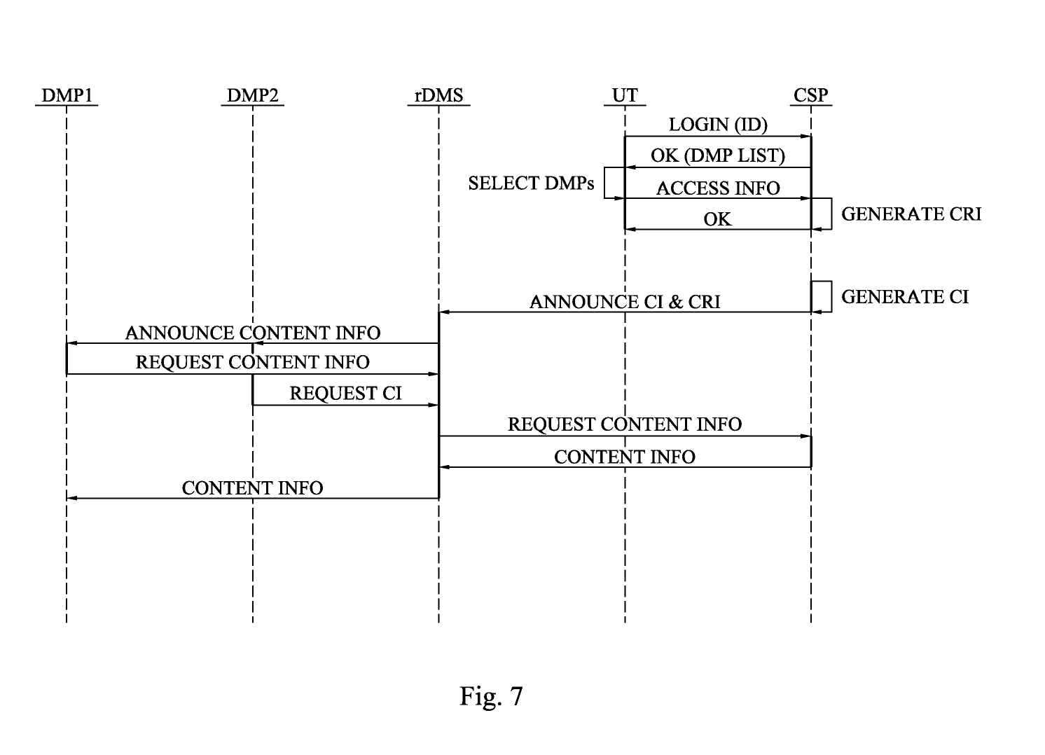

FIG. 7 is another signal diagram illustrating the communication of the including devices according to an embodiment. The operation is preferably started similar to FIG. 6 by the user stating the access information from the media rendering device to enable the content service provide to generate the content rights information. In this embodiment the content service provider announces the content information together with the content rights information. The media server then does not have to explicitly request the content rights from the content service provider.

The other signaling of this embodiment is conducted in the same way as in FIG. 6.

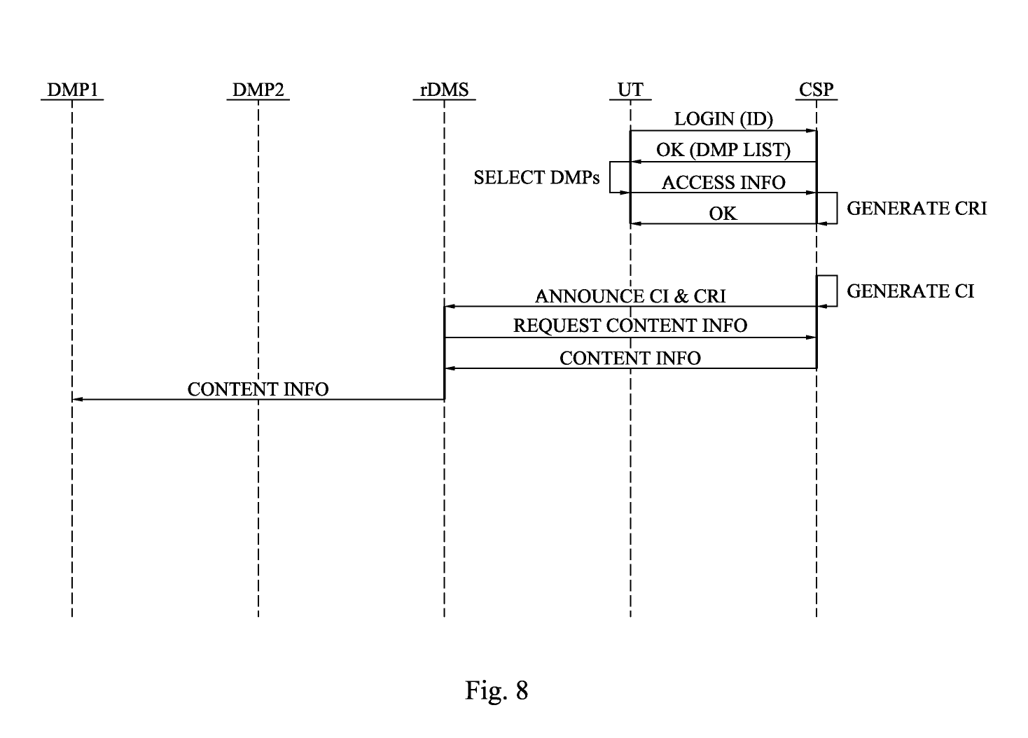

FIG. 8 is a further signal diagram illustrating the communication between the including devices according to an embodiment. The operation is preferably started similar to FIG. 7 up to the provision or announcement of the content information and the content information rights to the media server. In this embodiment, the media server does not make a multicast/broadcast announcement of the content information to all the media rendering devices. In clear contrast, the media server uses the content rights information to determine which media rendering device(s) that is(are) allowed access to the content information. The media server can then directly request the content information from the content service provider and transmit the received content information to the media rendering device(s), DMP1, that is(are) allowed access whereas other media rendering devices, DMP2, will not be notified that new or updated content information is available from the content service provider. The transmission of the content information is preferably conducted through one or more unicast transmission since it could be limited to one or a subset of the media rendering devices.

If different media rendering devices should have access to different parts of the content information as defined by the content rights information, the media server preferably conducts different transmissions with the different content information, e.g. XML data, to the media rendering devices.

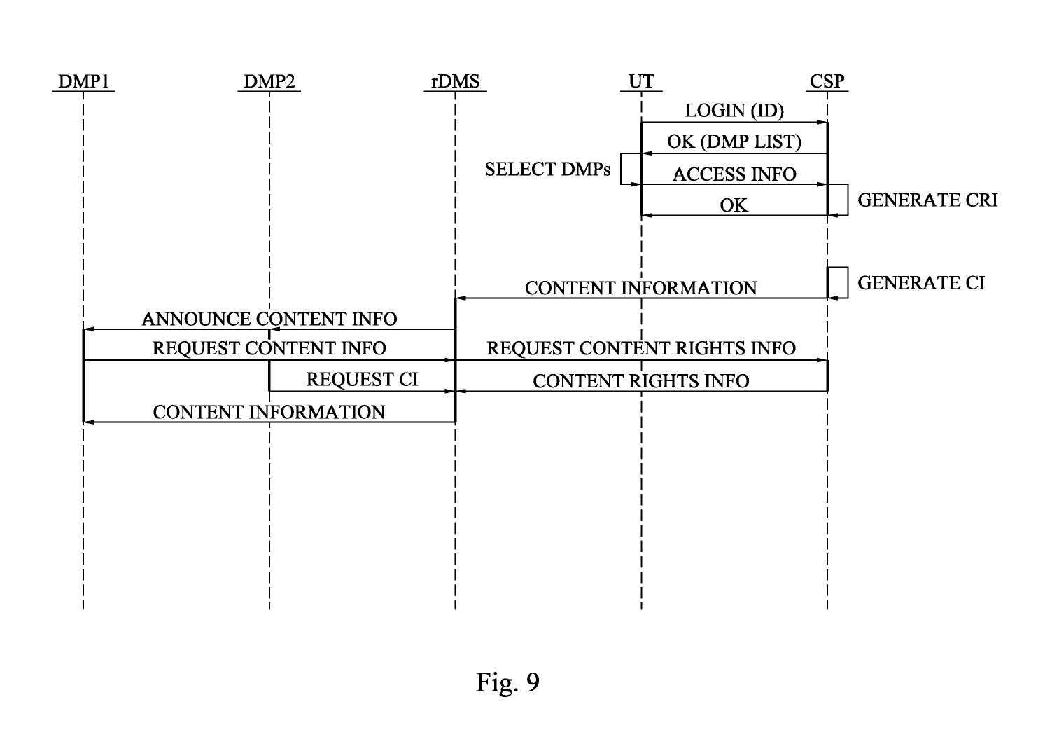

FIG. 9 is yet another signal diagram of the communication between the including devices according to an embodiment. In this example, the content service provider does not announce the content information by transmitting address(es) from where media server can fetch and download the content information and send it to the media rendering devices. In clear contrast, the content information itself is transmitted to the media server. This solution is in particular useful if the total size of the content information is quite small. This typically occurs for updates to previously announced and distributed content information. The content information transmitted as a whole can thereby simply define which media content asset(s) that has(have) been added or removed.

The media server makes an announcement that content information is available to the media rendering devices as described above in connection with FIG. 6. The remaining signaling is then the same as in FIG. 6 up to when the media server concludes, based on the content rights information, which media rendering device that should get access to the content information. In contrast to FIG. 6, the content information as received from the content service provider is transmitted to the identified media rendering device, thereby relaxing the need for generating content information requests and downloading the content information.

In this embodiment, the media server can control the distribution of the content information in more detail based on the content rights information. For instance, the media server, receiving the content information and not only an announcement and address thereof, can identify a subset of the content information based on the content rights information. This content information subset is then accessible to at least one media rendering device, whereas another media rendering device could be allowed access to the complete content information or another subset thereof.

The embodiments described above and disclosed in FIGS. 6 to 9 can be combined to form further alternatives. For instance, the transmission of the complete content information in FIG. 9 can be combined with the transmission of the content rights information as disclosed in FIGS. 7 and 8. Additionally, announcing the content information as illustrated in FIG. 9 can be replaced by a direct determination of the media rendering device(s) that should receive the content information as illustrated in FIG. 8.

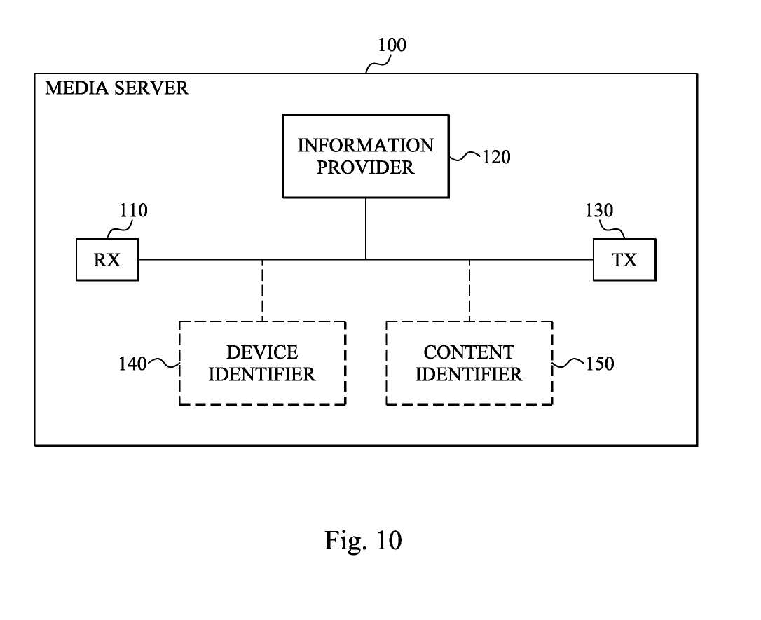

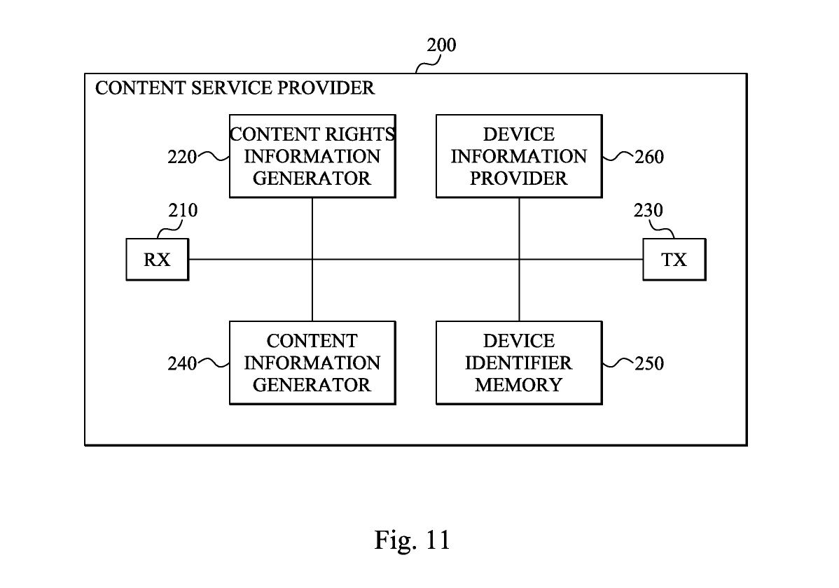

FIG. 10 is a schematic block diagram of a media server 100 according to an embodiment. The media server 100 is adapted for implementation in a local network and capable of conducting communication with media rendering device present in the local network.

The media server 100 comprises functionality for communicating with external devices. In the figure, this functionality has been exemplified by a receiver 110 and a transmitter 130. According to the present disclosure, a receiver 110 encompasses any unit or functionality allowing the media server 100 to receive information from a remote content service provider and connected media rendering devices. The receiver 110 can consequently be a dedicated receiver unit, a receiving branch of a transceiver or indeed a general input unit or functionality. Correspondingly, the transmitter 130 represents any functionality or unit, such as dedicated transmitter, transmitting branch of a transceiver or a general output unit or functionality, that is capable of transmitting information to the media rendering devices and preferably to the content service provider.

In an embodiment the same transmitter/receiver pair is used for communicating with the remote content service provider and the media rendering devices. Alternatively, a first transmitter/receiver pair is employed for the communication with the remote content service provider and a second transmitter/receiver pair is employed for the communication with the media rendering devices.

It is also possible for the media server 100 to utilize the communication units, i.e. receiver and transmitter, of the gateway arranged in the local network for performing the communication with the control service provider and optionally with the media rendering devices. In such a case, the receiver/transmitter functionality can be in the form of a general input and output (I/0) unit that forwards data between the media server and the gateway.

The receiver 110 is in particular implemented to receive content rights information from the remote content service provider. The content rights information defines rights to media content available at at least one content provider for the media rendering devices and is announced in content information. Additionally, the receiver 110 preferably also receives content information from the content service provider either as the actual information of the media content per se or in the form of one or more addresses at the content service provider from which the content information can be downloaded.

An information provider 120 of the media server 100 processes the content rights information from the receiver 110 for the purpose of achieving a selective and differentiated provision of content information to the media rendering devices. The information provider 120 thereby concludes based on the content rights information which media rendering device that should be granted access to the content information and optionally which part of the content information that should be available for the media rendering device.

The content information is then selectively transmitted to the media rendering device(s) according to the content rights information by the transmitter 130. The information provider 120 thereby controls the operation of the transmitter 130 to determine, preferably for each media rendering device, which part of the content information (ranging from the complete content information to no information at all) that the media rendering device should receive.

In a particular embodiment, the media server 100 comprises a device identifier 140 for identifying a subset of the media rendering devices based on the content rights information. The information provider 120 then controls the transmitter 130 to selectively transmit the content information (announcement) to the subset of media rendering devices identified by the device identifier 140.

In an alternative implementation, the media server 100 comprises a content identifier 150 that is operable based on the content rights information. The content identifier 150 is configured to identify a subset of the media content that is accessible to at least one media rendering device based on the content rights information. The information provider 120 controls the transmitter 130 to transmit the identified content information subset to the media rendering device.

In a further alternative implementation, the media server 100 comprises both the device identifier 140 and the content identifier 150. Through the combined operation of these identifiers 140, 150 the media server 100 can identify, for each media rendering device in the local network, the respective set of the media content that is accessible for the media rendering device according to the content rights information. The information provider 120 controls the transmitter 130 to transmit content information defining the respective set of media content to the media rendering devices unless a media rendering device should have no access to any media content, i.e. the set is the empty set.

An embodiment of the media server 100 has a transmitter 130 configured to transmit an announcement of the content information from the content service provider to the media rendering devices. The media rendering devices then respond by respective content information requests that are received by the receiver 110. The information provider 120 is in this embodiment configured to selectively provide the content information in response to the reception of the content information requests by the receiver 110.

The transmitter 130 may optionally transmit a content rights information request to the content service provider in response to the receiver 110 receiving the content information unless the content service provider automatically transmits the content rights information, for instance, together with the content information.

The transmitter 130 may also additionally transmit a request of the content information from the content service provider to receive the actual content information, e.g. in the form of XML data, unless this XML has already been sent by the content service provider to the receiver 110.

The units 110 to 150 of the media server 100 may be implemented or provided as software, hardware or a combination thereof. In the case of a software-based implementation, a computer program product implementing the media server 100 or a part thereof comprises software or a computer program run on a general purpose or specially adapted computer, processor or microprocessor. The software includes computer program code elements or software code portions illustrated in FIG. 10. The program may be stored in whole or part, on or in one or more suitable computer readable media or data storage means such as magnetic disks, CD-ROMs, DVD disks, USB memories, hard discs, magneto-optical memory, in RAM or volatile memory, in ROM or flash memory, as firmware, or on a data server.

The media server 100 is advantageously implemented in the gateway of the local network. Alternatively, a stand-alone media server device in wired or wireless connection with the gateway could be used. The communication functionalities of the gateway can be utilized by the media server for affecting the communication with the content service provider and optionally the media rendering devices.

FIG. 11 is a schematic block diagram of a content service provider 200 according to an embodiment. The content service provider 200 comprises a receiver 210 and a transmitter 230 for conducting communication with the media server in the local network, the user terminal and optionally media rendering devices present in the local network. This communication can be performed directly between the content service provider 200 and the media server/media rendering devices or through the gateway constituting the interface between the local network and the global network to which the content service provider 200 is connected.

The receiver 210 is in particular configured to receive a user identifier associated with the user having access to the media rendering devices in the local network. This user identifier is employed by a content rights information generator 220 for generating content rights information defining rights to media rendering devices to content information of media content available from one or more content providers. The transmitter 230 of the content service provider 230 is configured to transmit the content rights information to the media server to thereby enable a selective provision of the content information by the media server to the media rendering devices in the local network.

An optional device information provider 260 preferably processes the user identifier for the purpose of retrieving device information, such as device identifier or name, from a device identifier memory 250. This memory 250 comprises, for each user, information of the media rendering devices that is accessible for the user and which can all be implemented in a local network or may indeed be present in different local networks. The information of the media rendering devices has previously been entered in the memory 250 by the content service provider 200 when the media rendering devices announce their presence to the content service provider 200 as previously described.

The device information provider 260 preferably compiles a list of the media rendering devices available for the user identified by the user identifier. This list is transmitted to the user terminal by the transmitter 230 to allow the user to specify the content access information for media rendering devices. The receiver 210 thereby receiving, for at least one media rendering device, the device identifier and the user-selected content access information relating to the media rendering device associated with the device identifier. The content rights information generator 220 is configured in this embodiment to generate the content rights information based on the received device identifier(s), the user identifier and the content access information.

The content service provider 200 optionally comprises a content information generator 240 for compiling content information that is transmitted by the transmitter 230 to the media server. The content information can include the actual information of the media content assets or updates thereof relating to the media content at the content providers available for the content service provider 200. Alternatively, the content information includes one or more addresses to the content service provider from which the content information, e.g. in the form of XML data, can be fetched and downloaded by the media server. In such a case, the media server generates and transmits a content information request to the receiver 210 of the content service provider 200. The transmitter 230 then returns the media content information, e.g. in the form of XML data of the media content accessible to the media rendering devices at the content provider(s). The media server forwards this media content information to the media rendering device(s) granted access to the content information.

The transmitter 230 can transmit the content rights information together with the content information. Alternatively, the receiver 210 is configured to receive a content rights information request from the media server. The transmitter 230 then returns the content rights information generated by the content rights information generator 220 to the media server.

The units 210 to 260 of the content service provider 200 may be implemented or provided as software, hardware or a combination thereof. In the case of a software-based implementation, a computer program product implementing the content service provider 200 or a part thereof comprises software or a computer program run on a general purpose or specially adapted computer, processor or microprocessor. The software includes computer program code elements or software code portions illustrated in FIG. 11. The program may be stored in whole or part, on or in one or more suitable computer readable media or data storage means such as magnetic disks, CD-ROMs, DVD disks, USB memories, hard discs, magneto-optical memory, in RAM or volatile memory, in ROM or flash memory, as firmware, or on a data server.

The content service provider 200 can advantageously be implemented in a network node of the global network or at such a network node of a proprietary network connected to the global network.

The embodiments described above are to be understood as a few illustrative examples of the present invention. It will be understood by those skilled in the art that various modifications, combinations and changes may be made to the embodiments without departing from the scope of the present invention. In particular, different part solutions in the different embodiments can be combined in other configurations, where technically possible. The scope of the present invention is, however, defined by the appended claims.

1. A method of providing media content information to media rendering devices (12, 13, 14) present in a local network (2), said method comprising:
receiving, from a content service provider (200) connected to a global network (3) connected to said local network (2), content rights information defining rights to media content available at at least one content provider (30) for media rendering devices (12, 13, 14) associated with a user and present in said local network (2); and
selectively providing content information of said media content available at said at least one content provider (30) to at least one media rendering device (14) of said media rendering devices (12, 13, 14) based on said content rights information.

2. The method according to claim 1, further comprising:
receiving said content information from said content service provider (200);
announcing said content information to said media rendering devices (12, 13, 14); and
receiving content information requests from said media rendering devices (12, 13, 14), wherein said selectively providing step is performed in response to reception of said content information requests.

3. The method according to claim 2, further comprising transmitting a content rights information request to said content service provider (200) in response to reception of said content information.

4. The method according to any of the claims 1 to 3, wherein said selectively providing step comprises the steps of:
identifying a subset of said media rendering devices (12, 13, 14) based on said content rights information; and
transmitting said content information to said subset of said media rendering devices (12, 13, 14).

5. The method according to any of the claims 1 to 4, wherein said selectively providing step comprises:
identifying a subset of said media content that is accessible for said at least one media rendering device (14) based on said content rights information; and
transmitting content information defining said subset of said media content to said at least one media rendering device (14).

6. The method according to any of the claims 1 to 5, wherein said selectively providing step comprises:
identifying, for each media rendering device of said media rendering devices (12, 13, 14) and based on said content rights information, the respective set of said media content that is accessible for said media rendering device according to said content rights information; and
transmitting content information defining said respective set of said media content to said media rendering device unless said respective set is the empty set.

7. A content information control method comprising:
receiving a user identifier associated with a user having access to media rendering devices (12, 13, 14) present in a local network (2);
generating, based on said user identifier, content rights information defining rights for said media rendering devices (12, 13, 14) to content information of media content available at at least one content provider (30) connected to a global network (3) connected to said local network (2); and
transmitting said contents rights information to a media server (100) present in said local network (2) to enable a selective provision of said content information to at least one media rendering device (14) of said media rendering devices (12, 13, 14) based on said content rights information.

8. The method according to claim 7, further comprising transmitting said content information to said media server (100).

9. The method according to claim 8, wherein said step of transmitting said content information comprises:
transmitting, to said media server (100), address information at said content service provider (200) from which said content information can be download;
receiving a content information request from said media server (100) generated based on said address information; and
transmitting, to said media server (100), said content information defining media content accessible to said at least one media rendering device (14) at said at least one content provider (30).

10. The method according to any of the claims 7 to 9, further comprising receiving a content rights information request from said media server (100), wherein said step of transmitting said contents rights information is performed in response to reception of said content rights information request.

11. The method according to any of the claims 7 to 10, wherein said generating step comprises:
receiving, from a user terminal (20) associated with said user and connected to said global network (3), device identifier of said at least one media rendering device (14) and content access information relating to said at least one media rendering device (14) associated with said device identifier; and
generating said content rights information based on said device identifier, said content access information and said user identifier.

12. The method according to claim 11, further comprising:
providing, based on said user identifier, information of said media rendering devices (12, 13, 14) associated with said user; and
transmitting said information of said media rendering devices (12, 13, 14) to said user terminal (20).

13. The method according to claim 11 or 12, wherein said content access information specifies that said at least one media rendering device (14) is only allowed access to media content of a specified content type at said content service provider (200).

14. The method according to any of the claims 11 to 13, wherein said content access information specifies that said at least one media rendering device (14) is only allowed access to media content originating from a specified subset of content providers available (30) for said content service provider (200).

15. A media server (100) implementable in a local network (2) and connectable to media rendering devices (12, 13, 14) associated with a user and present in said local network (2), said media server (100) comprising:
a receiver (110) configured to receive, from a content service provider (200) connected to a global network (3) connected to said local network (2), content rights information defining rights to media content available at at least one content provider (30) for said media rendering devices (12, 13, 14); and
an information provider (120) configured to selectively provide content information of said media content available at said at least one content provider (30) to at least one media rendering device (14) of said media rendering devices (12, 13, 14) based on said content rights information.

16. The media server according to claim 15, wherein
said receiver (110) is configured to receive said content information from said content service provider (200);
said media server (100) further comprises a transmitter (130) configured to transmit an announcement of said content information to said media rendering devices (12, 13, 14);
said receiver (110) is additionally configured to receive content information requests from said media rendering devices (12, 13, 14); and
said information provider (120) is configured to selectively provide said content information in response to said receiver (110) receiving said content information requests.

17. The media server according to claim 16, wherein said transmitter (130) is configured to transmit a content rights information request to said content service provider (200) in response to said receiver (110) receiving said content information.

18. The media server according to any of the claims 15 to 17, further comprising a device identifier (140) configured to identify a subset of said media rendering devices (12, 13, 14) based on said content rights information, wherein said information provider (120) is configured to control a transmitter (130) to transmit said content information to said subset of said media rendering devices (12, 13, 14) identified by said device identifier (140).

19. The media server according to any of the claims 15 to 18, further comprising a content identifier (150) configured to identify a subset of said media content that is accessible for said at least one media rendering device (14) based on said content rights information, wherein said information provider (120) is configured to control a transmitter (130) to transmit, to said at least one media rendering device (14), content information defining said subset of said media content identified by said content identifier (150).

20. The media server according to any of the claims 15 to 19, further comprising an identifier (140, 150) configured to identify, for each media rendering device of said media rendering devices (12, 13, 14) and based on said content rights information, the respective set of said media content that is accessible for said media rendering device according to said content rights information, wherein said information provider (120) is configured to control a transmitter (130) to transmit content information defining said respective set of said media content to said media rendering device unless said respective set is the empty set.

21. A content service provider (200) connectable to a global network (3), said content service provider (200) comprises:
a receiver (210) configured to receive a user identifier associated with a user having access to media rendering devices (12, 13, 14) present in a local network (2) connected to said global network (3);
a rights information generator (220) configured to generate, based on said user identifier, content rights information defining rights for said media rendering devices (12, 13, 14) to content information of media content available at at least one content provider (30); and
a transmitter (230) configured to transmit said contents rights information to a media server (100) present in said local network (2) to enable a selective provision by said media server (100) of said content information to at least one media rendering device (14) of said media rendering devices (12, 13, 14) based on said content rights information.

22. The content service provider according to claim 21, further comprising a content information generator (240) configured to generate said content information, wherein said transmitter (230) is adapted to transmit said content information to said media server (100).

23. The content service provider according to claim 22, wherein
said transmitter (230) is configured to transmit, to said media server (100), address information at said content service provider (200) from which said content information can be download;
said receiver (210) is configured to receiver a content information request from said media server (100) generated based on said address information; and
said transmitter (230) is additionally configured to transmit, to said media server (100), said content information defining media content accessible to said at least one media rendering device (14) at said at least one content provider (30).

24. The content service provider according to any of the claims 21 to 23, wherein
said receiver (210) is configured to receive a content rights information request from said media server (100); and
said transmitter (230) is configured to transmit said contents rights information in response to said receiver (210) receiving said content rights information request.

25. The content service provider according to any of the claims 21 to 24, wherein
said receiver (210) is configured to receive, from a user terminal (20) associated with said user and connected to said global network (3), device identifier of said at least one media rendering device (14) and content access information relating to said at least one media rendering device (14) associated with said device identifier; and
said rights information generator (220) is configured to generate said content rights information based on said device identifier, said content access information and said user identifier.

26. The content service provider according to claim 25, further comprising a device information provider (260) configured to provide, based on said user identifier, information of said media rendering devices (12, 13, 14) associated with said user, wherein said transmitter (230) is configured to transmit said information of said media rendering devices (12, 13, 14) to said user terminal (20).
